(19) United States
(12) Patent Application Publication
(10) Pub. No.: US 2006/0200639 A1
(43) Pub. Date: Sep. 7, 2006

(54) System and method for computer backup and recovery using incremental file-based updates applied to an image of a storage device

(75) Inventors: Itzhak Levy, Hollywood, FL (US); Dario Oliva, Miami, FL (US); Lola Ogunkoya, Miramar, FL (US)

Correspondence Address: LERNER GREENBERG STEMER LLP, P O BOX 2480, HOLLYWOOD, FL, 33022-2480, US

(73) Assignee: Arco Computer Products, LLC

(21) Appl. No.: 11/073,876

(22) Filed: Mar. 7, 2005

(51) Int. Cl. G06F 12/16

(52) U.S. Cl. 711/162

(57) ABSTRACT

A backup and recovery system for a computer deals with the creation and subsequent incremental updating of an image copy of the data. This image copy is stored on a separate storage device (“backup storage device”) also connected to the computer system. By storing the image data on the backup storage device in a format that is directly usable by the operating system/file system on the user's computer, the invention gives the user access to a complete and up-to-date copy of their computer storage device, including all data stored therein such as that in the form of user files, applications, preferences, system files, partition tables, hidden partitions, and free space. In the event of failure of the computer system storage device, or loss or corruption of the data therein, the invention provides for the restoration of the data through an image- or file-copy of the contents of the backup storage device.

### BACKGROUND OF THE INVENTION

### Field of the Invention

The invention relates to the backup and restoration of data on storage devices. More specifically, the invention relates to a method of creating and updating an image of all the data on a storage device which is connected to a computer system, where the image is stored on a second storage device connected to the same computer system.

The term “storage device” (or “storage media device”) as used herein should be understood in a very broad sense. The term is used in this document to refer to any device which incorporates any combination of: a medium on which data can be stored and retrieved; and the logical and/or physical mechanism by which this storage and retrieval is performed. The data is assumed to be stored on the device in some non-volatile manner such that the data is not lost when the device is not connected to a power source. Some kinds of storage media devices in common use today include hard disk drives, compact discs (CD), and floppy disks. The method according to the invention works with, and should be understood to broadly apply to, all such devices as well as other devices, both those already and not yet in existence.

The term “computer system” as used herein should be understood in a very broad sense of the term. While the most common use of the invention will likely be for backup and recovery of desktop computers, laptop computers, and servers, the method according to the invention works with, or incorporated into, a multitude of other specialized devices such as point-of-sale terminals, telephony, computer numerical controllers, medical testing and monitoring equipment, and many other similar systems and devices. The invention should be understood to broadly apply to all such systems and devices.

A “connection” to a computer system should be understood to mean any tangible or intangible means of communication between the computer system and the storage device including but not limited to the following presently known means: software drivers, media drive, IDE, Universal Serial Bus (USB), IEEE 1394 (also known as FireWire®/iLink®), network connections, etc.

Modern computer systems are complex machines which depend on myriad interactions between many hardware components and even more software components (programs) in order to perform their tasks. If any of these components should fail or be corrupted, the computer system may be rendered unusable and data on any storage devices connected to it may become inaccessible, corrupted, and/or partially or entirely deleted.

The value of this data, and therefore of maintaining a functioning and functional computer system, is often incalculable. In many cases, the loss of the data would be a great disaster to the owners of the data, leading to financial, legal and other kinds of losses.

Since catastrophic occurrences such as these cannot be entirely avoided, computer system administrators and other users have long resorted to various schemes to mitigate the impact of such disasters on their ability to access and make use of their data.

These schemes often take the form of a backup and recovery solution, whereby data usually kept on a storage device connected to the computer (referred to as the system storage device) is copied on to another storage device (referred to as the backup storage device). In the event of disaster, any lost or corrupted data on the system storage device can be recovered from the backup storage device.

General Considerations in the Art:

Of course, in order for the data kept on the backup storage device to fulfill its purpose, it must meet certain conditions.

First of all, the data on the backup storage device must include any and all data on the system storage device that is needed to bring the computer system back to an operational state. There is no benefit to having a backup of a computer system that is missing some portion of data which is essential to restoring the value of that computer system, whether that data consists of user files needed for processing or reference, or of system files needed for the computer's normal operation.

So as to fully realize the previous clause, there is another provision which any good backup system must meet: the data on the backup storage device must be synchronized with the data on the system storage device. That is, the backup must be up-to-date. Depending on how often changes are made to the data on the system storage device, backups that are more than a few days old could be missing the most current user data and system updates which are often the most important when attempting to restore the computer system to its pre-disaster state.

In short, without frequently updated full backups of the computer system, the computer system administrator cannot perform a successful recovery of the system after a disaster.

Prior Art Approaches to Computer Backup and Restoration:

Two basic approaches are used in conventional systems to back up computer data which is saved on storage devices. One approach uses the logical concept of the file, as defined by the computer operating system (OS), as the basic unit of data, while the other approach employs the lower-level interface provided by the software driver for the storage device.

The file-oriented approach requires that the user or the computer system administrator specify the set of files on the computer that are to be backed up, the schedule or interval at which the backups are to take place, and the storage device to which the files are to be copied.

The advantage of file-oriented backup systems is that they are relatively straightforward. The typical user finds these systems easy to understand and simple to use. The user can easily restore an individual file or preset groups of files when needed, because the data on the backup storage device is stored in the OS file system format and is therefore accessible to users through the usual OS interface.

A key disadvantage of file-oriented backup systems is that they rely on the underlying OS and its file system for access to user data, so they require that the OS and file system be installed prior to system recovery. Also, most do not back up files that are part of the OS itself. This means that the user must keep the original OS installation media (or a copy of them) in order to be able to reinstall the OS when performing a full system recovery. Reinstallation of the OS alone can take hours, but the user will also have to find, retrieve and reapply any OS updates previously installed on the computer system as well as reset any user-defined OS settings, all of which are erased after a clean install of the OS.

Another drawback to file-copy backups is that the user needs to remember to back up all relevant user files (including applications, application settings files, user preferences, other utilities, etc.) and know where they are located in the file system in order to mark them for backup. Otherwise, during a full system recovery, all applications previously installed on the system will have to be reinstalled from their original installation media. In this case, all modified application settings, user preferences, program updates, or other custom enhancements will be lost and the user will have to reset them manually.

The other approach to backup systems uses something commonly referred to as an “image copy”, which is a block-by-block copy of data from one storage device to another. By bypassing the OS file system, an image-oriented backup system is able to work with low-level binary data (in chunks known as blocks). This means that an image-oriented backup system will copy 100.0% of the data and non-data stored on the system storage device on to the backup storage device, regardless of whether it is user data, system data, other structured information (such as partition tables, bootstrap code, etc), or even unknown/unstructured data.

The image-copy approach has the main advantage that the user or computer system administrator does not have to worry about which particular files need to be backed up or restored. This is because, in the process of doing an image copy, all files on the system storage device will be copied to the backup storage device. This includes all OS files, OS updates, applications, application settings files, application program updates, user preferences, and any other custom settings or enhancements applied to the computer system. All this information remains intact on the backup storage device and is copied back to the system storage device when the user performs an image-copy restore.

One disadvantage of an image-copy backup is that the image copy of a storage device is often compressed, compiled, encrypted, or otherwise modified in some way. This converts the binary data into a different format so that it can be stored on the backup storage device in a more compact form, usually as a single file or set of files; but it means that the data on the backup storage device is no longer in a format that the OS file system can understand. Until the image is decompressed, decompiled, and/or decrypted, the data on the backup storage device is inaccessible to the user.

Another consequence of this data modification is that each update to an image-copy backup is stored as a separate file (or set of files) on the backup storage device. Every time the user wants to perform a backup of the computer system, they have the choice of either running a full backup of the whole system or of running a partial backup that contains only the files or blocks on the disk that are new or changed since the last backup. With a typical image-copy backup system, the backup set produced from such a partial image-copy backup cannot be immediately combined with the last full image-copy backup set without decompressing the full backup set and then recompressing all the backup data into a single backup. That procedure would take a significant amount of time and use up significant amounts of the computer systems resources. Instead, the update data is saved as separate backup set (which is directly dependent on the full backup). For users who schedule or manually execute incremental updates to their backups on a regular basis, this means that a full system recovery could involve restoring multiple backup sets to the computer system, applying them one after the other and in order of creation. This could potentially take hours of precious time and leaves much room for user error, creating a greater likelihood of losing data during the recovery process.

### SUMMARY OF THE INVENTION

It is accordingly an object of the invention to provide a method for computer data backup and recovery as well as a corresponding system and computer-readable medium, which overcomes the above-mentioned disadvantages of the heretofore-known devices and methods of this general type. The primary object of the invention is to satisfy a need for a simple, intuitive means of backup that maintains a complete copy of all the data on a computer system storage device. This backup system should allow data on the backup storage device to be updated quickly with changes from the system storage device, so that the backup data can easily be made up-to-date as frequently as needed. The backup data should be stored in the computer's OS file system format, but it should still include any and all OS files (including those that may be in use at the time of backup) as well as other data on the computer system storage device that is under the control of the file system (yet that may still be very necessary for the total restoration of the state of the computer system and/or the system storage device).

With the above and other objects in view there is provided, in accordance with the invention, a computer data backup and restore system, comprising:

a backup storage device configured for connection to a computer with a computer storage device, said backup storage device having a data capacity capable of storing thereon an image copy of the computer storage device;

a computer-executable program configured for execution on the computer system, for offering a user of the computer a choice between backing up the computer storage device to said backup storage device and restoring data from said backup storage device to the computer storage device; and

said computer-executable program causing the computer, in dependence on the choice selected by the user, either writing a complete image copy of the computer storage device onto said backup storage device or restoring a complete image from said backup storage device to the computer storage device; and

a computer-executable program configured for execution on the computer system, causing the computer, in dependence on the choice selected by the user, either writing a certain set of files from the computer storage device onto said backup storage device or restoring a certain set of files from said backup storage device to the computer storage device.

With the above and other objects in view there is also provided, in accordance with the invention, a computerized backup and restore method, which comprises:

booting a computer and loading an instruction set including a user-interactive graphical user interface menu providing a user a choice between backing up a computer storage device to a backup storage device and restoring data from the backup storage device to the computer storage device; and

upon receiving user input and in dependence on the choice selected by the user, writing a complete image copy of the computer storage device to the backup storage device or restoring a complete image from the backup storage device to the computer storage device.

In accordance with an additional feature of the invention, the computer is booted to an operating system stored on a portable computer-readable medium and a reduced instruction set is loaded in that substantially only contains instructions for the user-interactive menu and the backup and restore operation.

There is also provided, in accordance with the invention, a computer-readable medium having stored thereon computer-executable instructions for performing the method.

Furthermore, the invention provides for a method that is applicable to a computer system having a graphical user interface with a display and a selection device. The invention is directed to a method of providing and selecting from a menu on the display, the method comprises:

booting to a computer operating system and retrieving a set of menu entries for the menu, the menu entries including a choice to back up a computer storage device to a backup storage device and a choice to restore data from the backup storage device to the computer storage device;

displaying the menu entries on the display;

scanning the computer system for a presence of a backup storage device suitable for receiving or containing an image copy of the computer storage device;

receiving a menu entry selection signal indicative of a selection entered by the user; and

depending on a selection made by the user, writing a complete image copy of the computer storage device to the backup storage device or restoring a complete image from the backup storage device to the computer storage device.

In other words, the invention provides for a method of computer system backup where, as a first step, a block-level image of the computer system's source storage device is copied to a backup storage device, but all subsequent updates to this backup are performed as file-oriented copy operations through the usual OS file system methods.

This combination scheme is an advantage over a purely file-oriented system in that it automatically provides for a complete backup of all (user and system) files on the source storage device without the user's intervention or even knowledge of these files and their locations.

Moreover it is an enhancement of the image-copy approach in that all image data is stored on the backup storage device in its native format (whether that is the format of the OS file system or some other format) rather than as a (compressed and/or compiled and/or encrypted) backup set. This assures the user and the computer system access (for reading, writing, or update) to any of the files on the backup storage device just easily as if they were copied using a file-oriented backup system. Also, the backup storage device receives the same characteristics that the source storage device has; i.e. any operation that could be performed on the source storage device can now also be performed on the backup storage device. For example, if the source storage device was bootable, the backup storage device becomes bootable as well.

In the use of the invention, so as to capture a stable state of the computer system during the image copy, some flexible but very compact operating system (OS) is used to boot up the system from a bootable storage device connected to the computer system. In one possible embodiment, Linux™ could be used as the operating system, a compact disc (CD) drive could be used as the bootable storage device, and the device media would be a bootable CD inserted into the CD drive. The CD would be loaded with the Linux operating system, the XWindow graphical library, and some image-copy software.

When the computer system is started up, the bootstrap code on the bootable storage device is executed which loads the operating system from the device. This operating system then takes over complete control of the computer system and loads the image copy software which verifies that a suitable backup storage device is connected to the computer system before starting a full image-copy backup. During this whole operation, the computer system OS (which may be stored on the source storage device) is completely idle. The image-copy operation is controlled solely by the operating system on the bootable storage device.

A full image-copy backup, in this instance, consists of reading blocks of data stored at a given logical block address (LBA) from the source storage device and writing those same blocks of data to the same LBA on the backup storage device, without modifying the data in any way. (Though this block-by-block copy may or may not occur in sequential order of logical block address (LBA). When all the blocks on the source storage device have been duplicated to the backup storage device, the image-copy backup is complete.

Now the computer system is rebooted in its usual manner to the computer system OS. From this point on, the user can operate the computer system as usual; the initial backup data has been stored to the backup storage device which can be mounted like any other storage device and accessed through the computer operating system. At this point, the backup storage device is an exact duplicate of the data on the source storage device.

Over time, the data on the computer system's source storage device will be changed. In the course of normal user operation, some files on the computer will be modified, added or deleted, and the source storage device will become out of sync with the backup storage device. At intervals, the user may desire to update the backup storage device with the changes to the source storage device.

To perform this update, first the user must ensure that the backup storage device is once again connected to the computer system. A file-copy operation is now executed, using file-copy software (or other means that the computer's operating system provides), to synchronize the backup storage device with the changes on the source storage device on a file-by-file basis. In one embodiment of the invention, the user can choose whether this update affects only a subset of the files on the source storage device or all files on the source storage device. When all the changes to files on the source storage device have been duplicated to the backup storage device, the file-copy backup is complete and the backup storage device has been updated.

If the computer system needs to be recovered, the user can choose whether to perform this recovery as a file-based or image-based operation. Doing a file-based recovery, of course, requires that the computer operating system and file system are operational; else, a full image restore is the only option.

In either case, the invention provides an interface for the user to initiate a copy of the data from the backup storage device to another storage device (often but not necessarily the source storage device). In many embodiments, this interface will be a graphical user interface (commonly known as GUI) to provide ease-of-use and user-friendliness, but the invention is not limited to this.

It is only specified that the backup storage device be connected to the computer system during backup and restore operations. At all other times, this is not a necessary condition of the invention.

Other features which are considered as characteristic for the invention are set forth in the appended claims.

### BRIEF DESCRIPTION OF THE FIGURES

FIG. 1 is a flowchart illustrating an overview of the process of backup and restore according to the approach laid out in this invention;

FIG. 2 is a flowchart illustrating the method of image-copy backup according to this invention; and

FIG. 3 is a flowchart illustrating the method of image-copy restore according to this invention.

### DETAILED DESCRIPTION OF A PREFERRED EMBODIMENT

We now show some figures to illustrate the process according to the invention, using an exemplary embodiment of this invention to make this process clear. In this description of the embodiment, a compact disc (CD) and compact disc drive provide the bootable storage device for the invention. The invention is not limited to this embodiment; rather the process according to the invention generally applies to all such storage devices that can be made bootable for a given computer system.

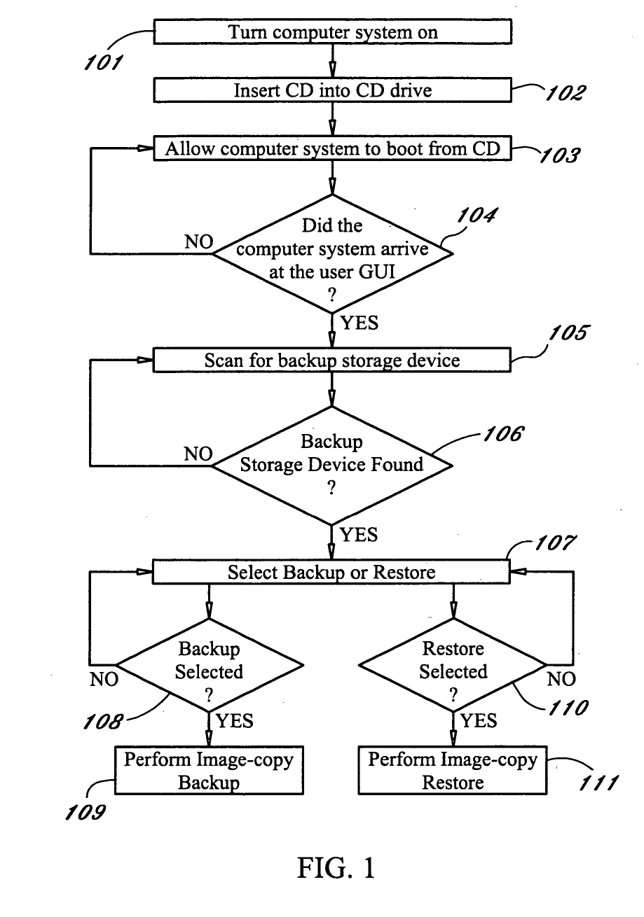

Referring now to the figures of the drawing in detail and first, particularly, to FIG. 1 thereof, there is shown an overview of a primary aspect of the backup process according to the invention. The figure details the process flow illustrating a computer system booting process.

The computer is turned on in a step 101. Before the computer has reached the stage in its boot-up sequence at which it scans the system for bootable storage devices from which it can acquire further boot instructions, the CD must be inserted into the CD drive at 102. At this time, the computer boots from the CD at step 103 and cycles through a query step 104 until the user GUI (graphical user interface) is established on the display. The GUI is provided by the instructions on the bootable CD. It provides the user only with few options, as will be explained in the following.

The computer also scans for a backup storage device in step 105 and the query step 106. The backup storage device finally selected, if it is to be deemed a suitable backup storage device, should at least have a capacity which is equal or greater than the source storage device to be backed up. In this embodiment, the source storage device is the computer system's internal hard disk drive. The system according to the invention, therefore, has a backup storage device with a capacity adapted to that of the computer system. If the computer system has, say, a 40 GB hard disk drive, the backup storage device will have a capacity of 40 GB or more in order to allow a complete 1:1 image of the source drive to be created on the backup device. Preferably, but not necessarily, the backup device is of the same type as the source device (e.g., a hard disk drive is preferably backed up to a hard disk drive).

Once a suitable backup storage device is found, and the query 106 returns a positive response, the user can be prompted to select from two choices at step 107, namely, to choose a system backup, or a system or file restore. If backup is selected at 108, the system creates an exact image copy of the source drive on the backup storage device, i.e., the target device at 109. The data stored on the target device is not changed in any way relative to the data retrieved from the source drive. That is, the data on the target device is a block-level copy of the source data. If, on the other hand, the user selects the restore option at 110, the system performs a data restore operation by copying data from the backup storage device to the system storage device. Here, again, the restore operation is a block-by-block copy operation. The entire set of information, that is system information and data, is moved from the backup storage device to the system storage device. The latter is thus placed exactly in a condition in which it was at the time of the last backup. Select file restore operations may be performed under control of the regular OS and with regular file copy and file restore operations provided by a program on the host computer.

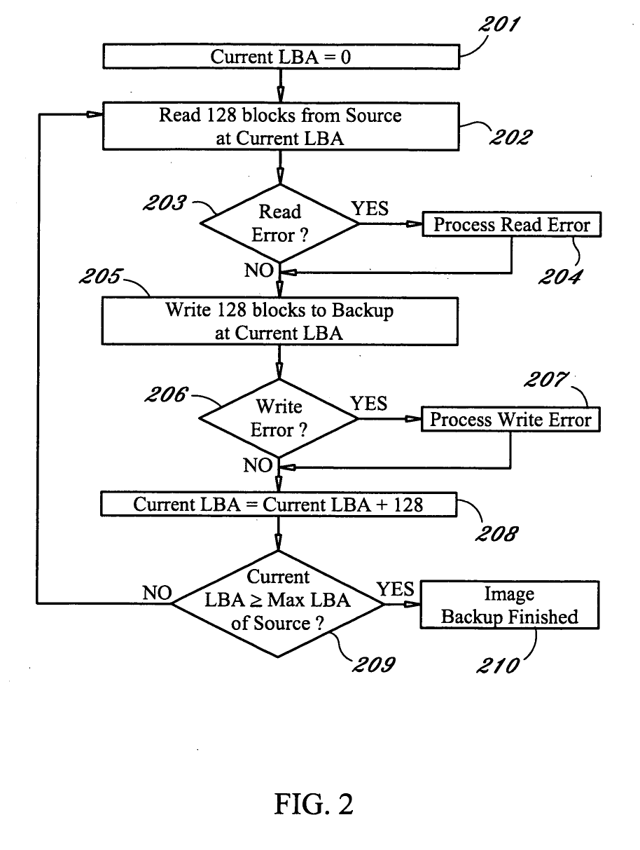

Referring now to FIG. 2, there is illustrated an exemplary program flow concerning a backup and image creation process. This exemplary program flow follows a sequential order to copy the blocks of data from the LBA on the source drive to the LBA on the target drive, though this is not necessary to the invention and may not always be the case. At initialization, the current LBA (logical block address) is set to zero at 201. Then a first 128 blocks of data are read at step 202 from the source drive, i.e., the computer system storage device. It will be understood, of course, that any number of blocks may be read, such as 256, or 64, or any related byte-multiplied number. After a read-error test at 203 and after read error processing, if necessary, at 204, the system writes the first 128 blocks to the target drive, i.e., the backup storage device at 205. The blocks are written at exactly the same LBA as the one used in step 202. The write operation is then verified in a query step 206 and, if necessary, the write error is processed in step 207. After the proper read/write cycle is confirmed, the variable representing the current LBA is incremented by the given block size in step 208. In the instant case, the increment is the read/write block size 128. If, in a following query 209, the current LBA has not reached the maximum LBA of the source device, the program cycles back to the step 202. If the maximum LBA has been reached, the source drive has been copied to the target drive in its totality and as a 1:1 image, and the program is considered finished at the step 210.

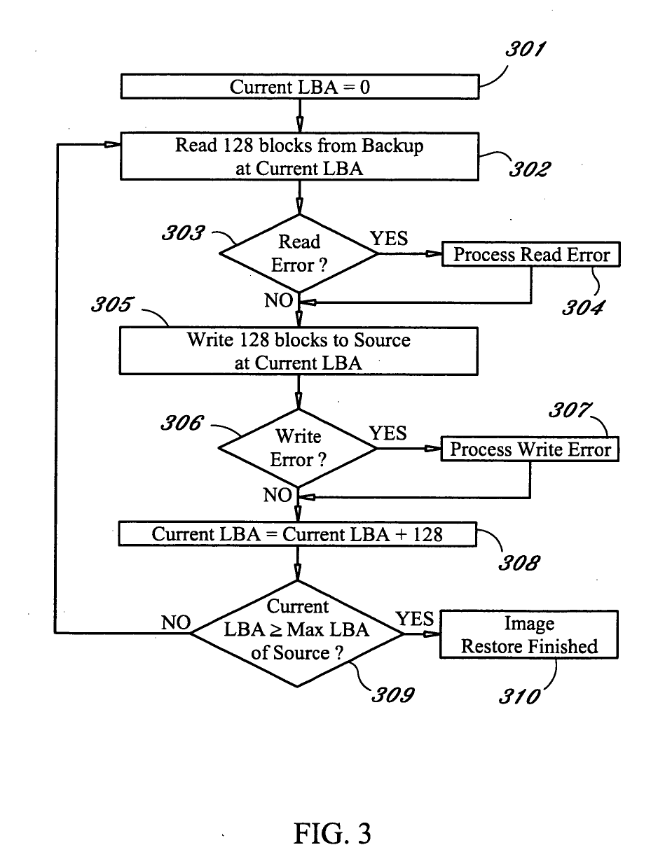

If the system storage device is to be restored, the computer executes the program flow illustrated in FIG. 3. There, the steps are quite similar to those of FIG. 2. In FIG. 3, the source drive is now the backup storage device and the target drive is the computer system storage device. First, the current LBA is set to zero at 301. Then a first 128 blocks of data are read at step 302 from the source drive, i.e., the backup storage device. After a read-error test at 303 and after read error processing, if necessary, at 304, the system writes the first 128 blocks to the target drive, i.e., the system storage device at 305. The blocks are written at exactly the same LBA as the one used in step 302. The write operation is then verified in a query step 306 and, if necessary, the write error is processed in step 307. After the proper read/write cycle is confirmed, the current LBA is incremented by 128. If in a following query 309, the current LBA has not reached the maximum LBA of the source device, the program cycles back to the step 302. If the maximum LBA has been reached, the source drive has been copied to the target drive in its totality and the restore routine is considered finished at step 310.

We claim:

1. A computer data backup and restore system, comprising:
a backup storage device configured for connection to a computer with a computer storage device, said backup storage device having a data capacity capable of storing thereon an image copy of the computer storage device;
a computer-executable program configured for execution on the computer system, for offering a user of the computer a choice between backing up the computer storage device to said backup storage device and restoring data from said backup storage device to the computer storage device; and
said computer-executable program causing the computer, in dependence on the choice selected by the user, either writing a complete image copy of the computer storage device onto said backup storage device or restoring a complete image from said backup storage device to the computer storage device; and
a computer-executable program configured for execution on the computer system, causing the computer, in dependence on the choice selected by the user, either writing a certain set of files from the computer storage device onto said backup storage device or restoring a certain set of files from said backup storage device to the computer storage device.

2. The system according to claim 1, wherein said backup storage device is an external hard disk drive and the computer storage device is an internal hard disk drive.

3. The system according to claim 1, which comprises a computer-readable medium having stored thereon the computer-executable program.

4. The system according to claim 1, wherein said computer-readable medium is a removable disk readable by a disk drive of the computer and being a bootable medium containing boot-up information and said computer-executable program.

5. A computerized backup and restore method, which comprises:
booting a computer and loading an instruction set including a user-interactive graphical user interface menu providing a user a choice between backing up a computer storage device to a backup storage device and restoring data from the backup storage device to the computer storage device; and
upon receiving user input and in dependence on the choice selected by the user, writing a complete image copy of the computer storage device to the backup storage device or restoring a complete image from the backup storage device to the computer storage device.

6. The method according to claim 5, which comprises booting to an operating system stored on a portable computer-readable medium and loading a reduced instruction set substantially only containing instructions for the user-interactive menu and the backup and restore operation.

7. A computer-readable medium having stored thereon computer-executable instructions for performing the method according to claim 5.

8. In a computer system having a graphical user interface with a display and a selection device, a method of providing and selecting from a menu on the display, the method which comprises:
booting to a computer operating system and retrieving a set of menu entries for the menu, the menu entries including a choice to back up a computer storage device to a backup storage device and a choice to restore data from the backup storage device to the computer storage device;
displaying the menu entries on the display;
scanning the computer system for a presence of a backup storage device suitable for receiving or containing an image copy of the computer storage device;
receiving a menu entry selection signal indicative of a selection entered by the user; and
depending on a selection made by the user, writing a complete image copy of the computer storage device to the backup storage device or restoring a complete image from the backup storage device to the computer storage device.
